(19) United States
(12) Patent Application Publication
(10) Pub. No.: US 2026/0117719 A1
(43) Pub. Date: Apr. 30, 2026

(54) INTERNAL COMBUSTION ENGINE SYSTEM

(71) Applicant: TOYOTA JIDOSHA KABUSHIKI KAISHA, Toyota-shi (JP)

(72) Inventors: Yuji YAMAGUCHI, Gotemba-shi (JP); Taisuke YOSHIDA, Susono-shi (JP)

(73) Assignee: TOYOTA JIDOSHA KABUSHIKI KAISHA, Toyota-shi (JP)

(21) Appl. No.: 19/298,377

(22) Filed: Aug. 13, 2025

(30) Foreign Application Priority Data
Oct. 29, 2024 (JP) 2024-189942

(51) Int. Cl. F02D 41/14; F01N 13/00

(52) U.S. Cl. CPC F02D 41/1402; F01N 13/0093; F02D 41/1441; F02D 41/1454; F02D 2200/0816

(57) ABSTRACT

An internal combustion engine system executes processing of performing feedback control of an air-fuel ratio such that exhaust gas of an internal combustion engine has a target air-fuel ratio, target air-fuel ratio switching processing of alternately varying the target air-fuel ratio between a lean side and a rich side from an air-fuel ratio center value, processing of setting the air-fuel ratio center value, processing of calculating a first parameter indicating variation in air-fuel ratio for each cylinder, processing of calculating a second parameter indicating variation in gas impingement degree for each cylinder, the gas impingement degree to which the exhaust gas exhausted from each of cylinder impinges on a second air-fuel ratio sensor downstream of a first exhaust gas cleaning catalyst, and processing of setting an amplitude of the target air-fuel ratio in the target air-fuel ratio switching processing based on the first and second parameters.

### CROSS-REFERENCE TO RELATED APPLICATION

This application claims priority to Japanese Patent Application No. 2024-189942 filed on October 29, 2024. The disclosure of the above-identified application, including the specification, drawings, and claims, is incorporated by reference herein in its entirety.

### BACKGROUND

### 1. Technical Field

The present disclosure relates to an internal combustion engine system, and particularly relates to an internal combustion engine system that cleans exhaust gas exhausted from an internal combustion engine using an exhaust gas cleaning catalyst.

### 2. Description of Related Art

Japanese Unexamined Patent Application Publication No. 2016-31038 (JP 2016-31038 A) discloses a technology related to a control device for suppressing an outflow of NOx and unburned gas from an exhaust gas cleaning catalyst. An internal combustion engine of the technology is provided with an exhaust gas cleaning catalyst, a downstream air-fuel ratio sensor disposed downstream of the exhaust gas cleaning catalyst, and an air flow meter that detects an intake air amount. Then, the control device performs feedback control such that an exhaust air-fuel ratio of the internal combustion engine reaches a target air-fuel ratio. Then, the control device sets the target air-fuel ratio to a lean air-fuel ratio in a case where an output air-fuel ratio of the downstream air-fuel ratio sensor reaches a rich air-fuel ratio, and sets the target air-fuel ratio to the rich air-fuel ratio in a case where the output air-fuel ratio of the downstream air-fuel ratio sensor reaches the lean air-fuel ratio.

### SUMMARY

In the technology of JP 2016-31038 A, in a case where the output air-fuel ratio of the downstream air-fuel ratio sensor is steadily shifted toward a rich side or a lean side, it is considered to perform learning control of learning and correcting a shift of a control center value of the target air-fuel ratio. Here, in an internal combustion engine including a plurality of cylinders, depending on an operation condition of the internal combustion engine, variations in gas impingement strength with which exhaust gas of each of the cylinders impinges on the downstream air-fuel ratio sensor installed downstream of an exhaust gas cleaning catalyst and variations in an air-fuel ratio of the exhaust gas of each of the cylinders may occur. Therefore, when the learning control is performed in a device of JP 2016-31038 A, in a case where the variations in gas impingement strength with which the exhaust gas impinges on the downstream air-fuel ratio sensor and the variations in the air-fuel ratio of the exhaust gas occur for each of the cylinders, it is erroneously detected that an average air-fuel ratio of the entirety of the cylinders is shifted. In this case, the control center value is changed based on a value of the erroneous detection. As a result, in a case where an amount of reduction or an amount of oxidation of the gas flowing into the exhaust gas cleaning catalyst is insufficient, there is a concern that a cleaning ability of the exhaust gas cleaning catalyst cannot be sufficiently utilized.

The present disclosure has been made in view of the issue, and there is provided an internal combustion engine system in which an influence of variations in air-fuel ratio for each of cylinders of an internal combustion engine and variations in gas impingement on an air-fuel ratio sensor for each of the cylinders is taken into consideration. Accordingly, an object of the present disclosure is to provide an internal combustion engine system that can effectively utilize a cleaning ability of an exhaust gas cleaning catalyst.

In order to solve the issue, the present disclosure provides an internal combustion engine system. The internal combustion engine system includes a first exhaust gas cleaning catalyst disposed in an exhaust passage of an internal combustion engine including a plurality of cylinders, a second exhaust gas cleaning catalyst disposed downstream of the first exhaust gas cleaning catalyst in an exhaust flow direction, a first air-fuel ratio sensor disposed upstream of the first exhaust gas cleaning catalyst in the exhaust flow direction in the exhaust passage, a second air-fuel ratio sensor disposed downstream of the first exhaust gas cleaning catalyst in the exhaust flow direction in the exhaust passage and upstream of the second exhaust gas cleaning catalyst in the exhaust flow direction in the exhaust passage, and a control device configured to control the internal combustion engine. The control device is configured to execute: feedback processing of performing feedback control of an air-fuel ratio of exhaust gas exhausted from the internal combustion engine such that a first air-fuel ratio detected by the first air-fuel ratio sensor reaches a target air-fuel ratio; target air-fuel ratio switching processing of alternately varying the target air-fuel ratio between a lean side and a rich side from an air-fuel ratio center value; learning control processing of setting, based on a second air-fuel ratio detected by the second air-fuel ratio sensor, the air-fuel ratio center value in the target air-fuel ratio switching processing; first parameter calculation processing of calculating a first parameter indicating a variation in an air-fuel ratio for each of the cylinders of the internal combustion engine; second parameter calculation processing of calculating, based on an operation condition of the internal combustion engine, a second parameter indicating variation in a gas impingement degree for each of the cylinders, the gas impingement degree being a degree to which the exhaust gas exhausted from each of the cylinders of the internal combustion engine impinges on the second air-fuel ratio sensor; and amplitude setting processing of setting, based on the first parameter and the second parameter, an amplitude of the target air-fuel ratio in the target air-fuel ratio switching processing.

In addition, in the amplitude setting processing according to the present disclosure, the control device may be configured to set the amplitude to a larger value as the first parameter indicates a larger variation in the air-fuel ratio for each of the cylinders.

Further, in the amplitude setting processing of the present disclosure, the control device may be configured to set the amplitude to a larger value as the second parameter indicates a larger variation in the gas impingement degree for each of the cylinders.

With the internal combustion engine system according to the present disclosure, the cleaning ability of the exhaust gas cleaning catalyst can be effectively utilized by taking into consideration the influence of the variations in air-fuel ratio for each of the cylinders and the variations in gas impingement on the air-fuel ratio sensor for each of the cylinders.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing a configuration of an internal combustion engine system according to an embodiment;

FIG. 2 is a diagram showing a functional block of an ECU;

FIG. 3 is a time chart showing a change in various states in a case where amplitude setting processing is executed by the internal combustion engine system according to the embodiment;

FIG. 4 is a diagram showing an example of a map in which a rich set value and a lean set value for a degree of variation in air-fuel ratio between cylinders and a degree of variation in gas impingement degree of exhaust gas between the cylinders are defined; and

FIG. 5 is a flowchart showing a routine of processing executed in the internal combustion engine system according to the embodiment.

### DETAILED DESCRIPTION OF EMBODIMENTS

Hereinafter, embodiments of the present disclosure will be described. However, in a case where the number, the quantity, the amount, the range, or the like of each element is mentioned in the embodiments shown below, the number, the quantity, the amount, the range, or the like is not limited to the mentioned number, unless the number is specified as being limited to the mentioned number in a case where the number is particularly emphasized or is principally clearly specified. In addition, the structures, the steps, and the like described in the embodiments shown below are not necessarily mandatory to the present disclosure, unless the structures, the steps, and the like are particularly emphasized or are principally clearly specified.

### Embodiment

### 1. Configuration of Embodiment

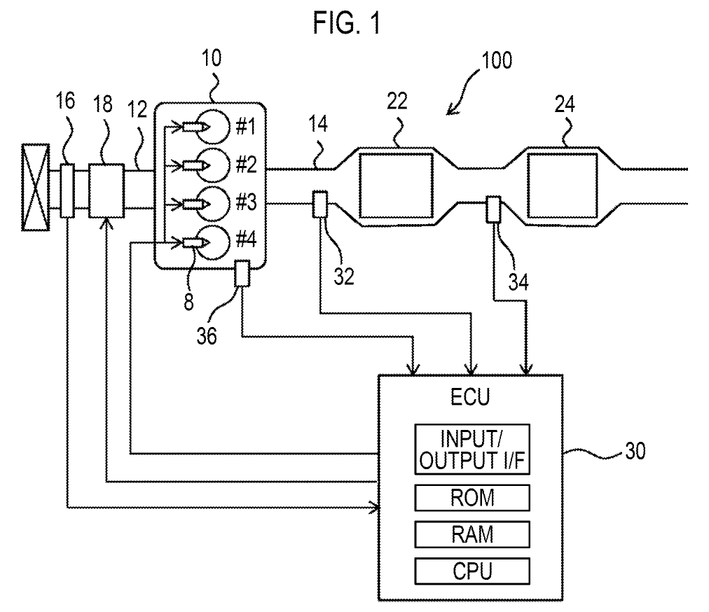

FIG. 1 is a diagram for describing a configuration of an internal combustion engine system according to an embodiment. As shown in FIG. 1, an internal combustion engine system 100 according to the present embodiment includes an internal combustion engine (engine) 10 including a plurality of cylinders. The engine 10 is mounted on a vehicle as a power source. The engine 10 is a gasoline engine based on stoichiometric combustion according to a stoichiometric air-fuel ratio. The engine 10 includes four cylinders from a #1 cylinder to a #4 cylinder in series, and an injector 8 is provided for each of the cylinders. An intake manifold and an exhaust manifold are attached to the engine 10 (both are not shown). An intake passage 12 for taking in air to the engine 10 is connected to the intake manifold. An exhaust passage 14 for releasing exhaust gas discharged from the engine 10 into the atmosphere is connected to the exhaust manifold.

An air flow meter 16 for detecting an intake air amount Ga is disposed in the middle of the intake passage 12. A throttle valve 18 is provided downstream of the air flow meter 16 in an intake flow direction in the intake passage 12. A first exhaust gas cleaning catalyst 22 is disposed in the exhaust passage 14. A second exhaust gas cleaning catalyst 24 is disposed downstream of the first exhaust gas cleaning catalyst 22 in an exhaust flow direction in the exhaust passage 14.

For example, both the first exhaust gas cleaning catalyst 22 and the second exhaust gas cleaning catalyst 24 have the same configuration. The first exhaust gas cleaning catalyst 22 and the second exhaust gas cleaning catalyst 24 are three-way catalysts having an oxygen storage ability. Specifically, the first exhaust gas cleaning catalyst 22 and the second exhaust gas cleaning catalyst 24 are catalysts that are supported with a base material made of ceramic, a noble metal, such as platinum (Pt) having a catalyst action, and ceria (CeO₂) having an oxygen storage ability. In a case where the first exhaust gas cleaning catalyst 22 and the second exhaust gas cleaning catalyst 24 is reached to a predetermined activation temperature, the first exhaust gas cleaning catalyst 22 and the second exhaust gas cleaning catalyst 24 exhibit a catalyst action of cleaning unburned gas (HC, CO, and the like) and nitrogen oxide (NOx) at the same time, and the oxygen storage ability of storing oxygen.

According to the oxygen storage ability of the first exhaust gas cleaning catalyst 22 and the second exhaust gas cleaning catalyst 24, in a case where the air-fuel ratio of the exhaust gas flowing into the first exhaust gas cleaning catalyst 22 and the second exhaust gas cleaning catalyst 24 is a lean air-fuel ratio leaner than the stoichiometric air-fuel ratio, oxygen in the exhaust gas is stored. On the other hand, in a case where the air-fuel ratio of the flowing-in exhaust gas is a rich air-fuel ratio richer than the stoichiometric air-fuel ratio, the first exhaust gas cleaning catalyst 22 and the second exhaust gas cleaning catalyst 24 release the oxygen stored in the first exhaust gas cleaning catalyst 22 and the second exhaust gas cleaning catalyst 24. The types and the structures of the first exhaust gas cleaning catalyst 22 and the second exhaust gas cleaning catalyst 24 are not limited as long as the first exhaust gas cleaning catalyst 22 and the second exhaust gas cleaning catalyst 24 have a catalyst action of cleaning the exhaust gas and the oxygen storage ability.

The internal combustion engine system 100 according to the present embodiment includes an electronic control unit (ECU) 30. The ECU 30 is a control device that integrally controls an entirety of the internal combustion engine system 100. The control device according to the present disclosure is realized as one function of the ECU 30.

The ECU 30 has at least an input/output interface, a ROM, a RAM, and a central processing unit (CPU). The input/output interface takes in a signal of a sensor included in the internal combustion engine system 100 and outputs an operation signal to an actuator included in the engine 10. The sensor is attached to each location of the internal combustion engine system 100. A first air-fuel ratio sensor 32 is provided upstream of the first exhaust gas cleaning catalyst 22 in the exhaust passage 14. The first air-fuel ratio sensor 32 detects an air-fuel ratio of the exhaust gas exhausted from the engine 10 to the exhaust passage 14 as a first air-fuel ratio. A second air-fuel ratio sensor 34 is provided downstream of the first exhaust gas cleaning catalyst 22 in the exhaust flow direction and upstream of the second exhaust gas cleaning catalyst 24 in the exhaust flow direction in the exhaust passage 14. The second air-fuel ratio sensor 34 detects an air-fuel ratio of the exhaust gas that flows out from the first exhaust gas cleaning catalyst 22 and flows into the second exhaust gas cleaning catalyst 24, as a second air-fuel ratio. Further, a rotation speed sensor 36 that detects an engine rotation speed NE of the engine 10 and various sensors for detecting a state of the engine 10 are also mounted. The ECU 30 processes the signal of each sensor taken in and operates each actuator according to a predetermined control program.

The actuator operated by the ECU 30 includes the injector 8, the throttle valve 18, and the like. The ROM stores various types of control data including various control programs and maps for controlling the engine 10. The CPU reads out and executes the control program from the ROM and generates an operation signal based on the taken-in sensor signal. Although there are a large number of actuators and sensors connected to the ECU 30 in addition to sensors shown in the drawing, description thereof will be omitted in the present specification.

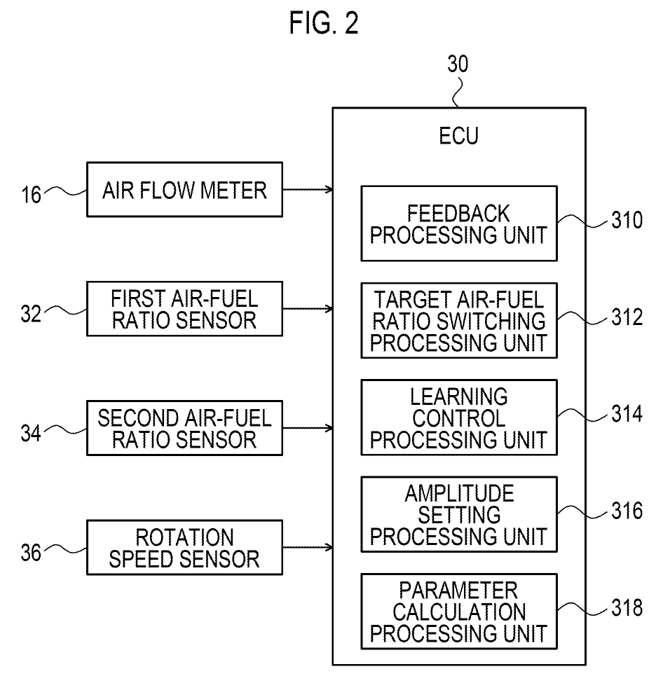

FIG. 2 is a diagram showing a functional block of the ECU. The ECU 30 includes a feedback processing unit 310, a target air-fuel ratio switching processing unit 312, a learning control processing unit 314, and an amplitude setting processing unit 316, as functional blocks for controlling the internal combustion engine system 100. Hereinafter, processing executed in each functional block will be described in detail.

### 2. Basic Operation of Internal Combustion Engine System according to Embodiments

### 2-1. Feedback Processing

The control of the engine 10 executed by the ECU 30 of the internal combustion engine system 100 includes feedback processing. The feedback processing is executed in the feedback processing unit 310 of the ECU 30. In the feedback processing of the present embodiment, a fuel injection amount from the injector 8 is subjected to feedback control such that the first air-fuel ratio detected by the first air-fuel ratio sensor 32 is the target air-fuel ratio. The target air-fuel ratio here is, for example, the stoichiometric air-fuel ratio (A/F 14.60).

### 2-2. Target Air-Fuel Ratio Switching Processing

The control of the engine 10 executed by the ECU 30 of the internal combustion engine system 100 includes target air-fuel ratio switching processing. The target air-fuel ratio switching processing is executed in the target air-fuel ratio switching processing unit 312 of the ECU 30. In the target air-fuel ratio switching processing of the present embodiment, the target air-fuel ratio is alternately switched between a lean set value and a rich set value such that the air-fuel ratio of the exhaust gas is alternately varied between a lean side and a rich side from an air-fuel ratio center value. Specifically, in the target air-fuel ratio switching processing, the ECU 30 is configured to set the target air-fuel ratio to the lean set value in a case where the second air-fuel ratio detected by the second air-fuel ratio sensor 34 is equal to or less than a rich determination value that is richer than the stoichiometric air-fuel ratio. In addition, the ECU 30 is configured to set the target air-fuel ratio to the rich set value in a case where the second air-fuel ratio is equal to or greater than a lean determination value that is leaner than the stoichiometric air-fuel ratio. The air-fuel ratio center value here is a value set in learning control processing to be described later, and for example, an initial value thereof is set to the stoichiometric air-fuel ratio.

In a case where an internal oxygen storage capacity is maintained almost constant, the exhaust gas cleaning catalyst capable of storing oxygen faces a decrease in the oxygen storage ability. Therefore, in order to maintain the oxygen storage ability as much as possible, it is preferable to alternately change the internal oxygen storage capacity between a storage amount close to zero and a storage amount close to the maximum storage amount during use of the exhaust gas cleaning catalyst. According to the target air-fuel ratio switching processing according to the present embodiment, the target air-fuel ratio is alternately switched between the lean set value and the rich set value. Therefore, the oxygen storage capacities of the first exhaust gas cleaning catalyst 22 and the second exhaust gas cleaning catalyst 24 are repeatedly increased and decreased. Accordingly, since the oxygen storage capacities of the first exhaust gas cleaning catalyst 22 and the second exhaust gas cleaning catalyst 24 can be maintained as high as possible, a degree of effective utilization of the first exhaust gas cleaning catalyst 22 and the second exhaust gas cleaning catalyst 24 is improved.

### 2-3. Learning Control Processing

The control of the engine 10 executed by the ECU 30 of the internal combustion engine system 100 includes learning control processing. The learning control processing is executed in the learning control processing unit 314 of the ECU 30. In the learning control processing of the present embodiment, the air-fuel ratio center value in the target air-fuel ratio switching processing is set. Specifically, in the learning control processing, the initial value of the air-fuel ratio center value is set to the stoichiometric air-fuel ratio. In a case where the engine 10 is operated, an oxygen storage capacity during a period in which the target air-fuel ratio is varied to the lean side in the target air-fuel ratio switching processing and an oxygen consumption amount during a period in which the target air-fuel ratio is varied toward the rich side in the target air-fuel ratio switching processing are calculated. The calculation is based on the second air-fuel ratio detected by the second air-fuel ratio sensor 34 and the intake air amount Ga detected by the air flow meter 16. Then, the air-fuel ratio center value is set such that the calculated oxygen storage capacity and the calculated oxygen consumption amount are equal to each other.

### 3. Feature Operation of Internal Combustion Engine System according to Embodiments

### 3-1. Amplitude Setting Processing

The control of the engine 10 executed by the ECU 30 of the internal combustion engine system 100 includes amplitude setting processing. The amplitude setting processing is executed in the amplitude setting processing unit 316 of the ECU 30.

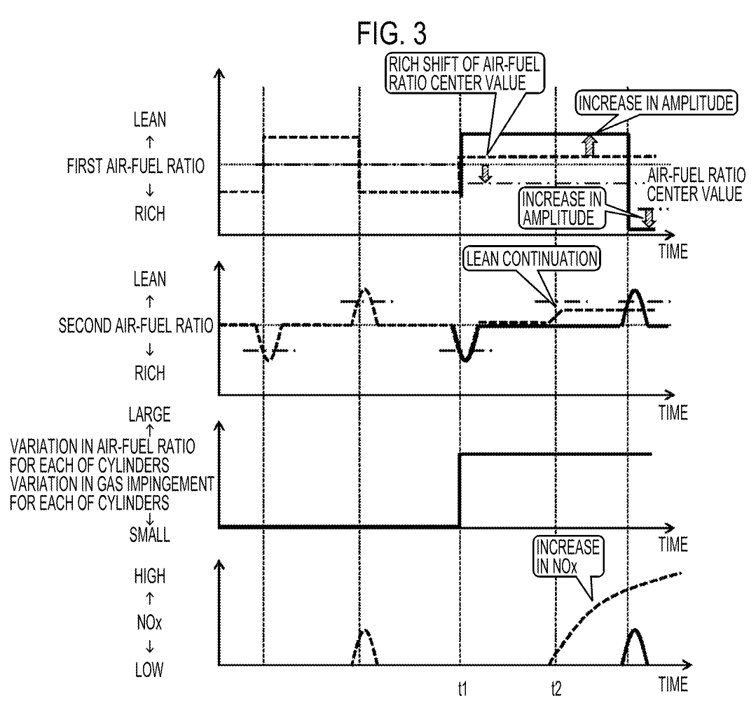

FIG. 3 is a time chart showing a change in various states in a case where the amplitude setting processing is executed by the internal combustion engine system according to the embodiment. In FIG. 3, a solid line indicates an operation example of the internal combustion engine system 100 of an embodiment in which the amplitude setting processing is executed, and a broken line indicates an operation example of an internal combustion engine system of a comparative example in which the amplitude setting processing is not executed.

In a case where the engine 10 is, for example, a four-cylinder naturally aspirated engine, the engine rotation speed NE and the engine load KL change, and a case is considered in which the engine 10 changes to the following state at time t1 of the time chart shown in FIG. 3.

The air-fuel ratios of the exhaust gas of the #1 cylinder and the #2 cylinder vary to the lean side, and the air-fuel ratios of the exhaust gas of the #3 cylinder and the #4 cylinder vary to the rich side.

The gas impingement of the exhaust gas of the #1 cylinder and the #2 cylinder with the second air-fuel ratio sensor 34 is strong, and the gas impingement of the exhaust gas of the #3 cylinder and the #4 cylinder is weak as compared with the #1 cylinder and the #2 cylinder.

In this case, since a detection value of the second air-fuel ratio sensor 34 is strongly affected by the air-fuel ratios of the exhaust gas of the #1 cylinder and the #2 cylinder having strong gas impingement, the second air-fuel ratio is a value on the lean side of an average value of the air-fuel ratios of all the cylinders. Therefore, in a case where there are variations in the air-fuel ratio and the gas impingement between the cylinders as described above, the following problems occur. In a case where the learning control processing is executed based on the second air-fuel ratio detected by the second air-fuel ratio sensor 34, as shown in FIG. 3, processing of shifting the air-fuel ratio center value toward the rich side is performed. In this case, the air-fuel ratios of the exhaust gas of the #3 cylinder and the #4 cylinder are further shifted toward the rich side, and the cleaning performance of the first exhaust gas cleaning catalyst 22 and the second exhaust gas cleaning catalyst 24 is deteriorated.

In addition, as in the comparative example in FIG. 3, in a case where the target air-fuel ratio is set to the lean set value by the target air-fuel ratio switching processing at time t1, the following problems occur. Since the air-fuel ratio center value is shifted toward the rich side by the learning control processing, a lean degree of the lean set value is reduced. As a result, there is a concern that the second air-fuel ratio does not reach the lean determination value at time t2 or a time taken to reach the lean determination value is long, and the cleaning performance of the first exhaust gas cleaning catalyst 22 and the second exhaust gas cleaning catalyst 24 is deteriorated due to the continuation of the lean operation. The deterioration in the cleaning performance of the first exhaust gas cleaning catalyst 22 and the second exhaust gas cleaning catalyst 24 can similarly occur in a case where the second air-fuel ratio is a value on a rich side of the average value of the air-fuel ratios of all the cylinders, in a case where there are variations in the air-fuel ratio and the gas impingement between the cylinders.

In the internal combustion engine system 100 according to the embodiment, the lean set value and the rich set value are set as follows in the amplitude setting processing. As the variation in air-fuel ratio between the cylinders is larger and the variation in gas impingement degree between the cylinders, with which the exhaust gas exhausted from each of the cylinders impinges on the second air-fuel ratio sensor 34, is larger, the amplitude of the target air-fuel ratio in the target air-fuel ratio switching processing is increased.

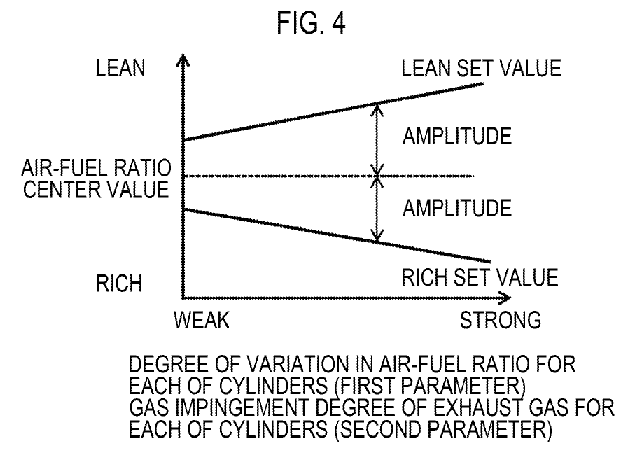

FIG. 4 is a diagram showing an example of a map in which the rich set value and the lean set value for a degree of variation in air-fuel ratio between cylinders and a degree of variation in gas impingement degree of exhaust gas between the cylinders are defined. In the map shown in FIG. 4, the rich set value and the lean set value are defined corresponding to the first parameter and the second parameter. The rich set value and the lean set value are used in the target air-fuel ratio switching processing. The first parameter is a parameter in which the degree of variation in air-fuel ratio between the cylinders is digitized. The second parameter is a parameter in which the degree of variation in gas impingement degree of the exhaust gas between the cylinders is digitized. The ECU 30 stores the map shown in FIG. 4 in the ROM.

The amplitude setting processing unit 316 reads out, for example, the map shown in FIG. 4 from the ROM and specifies the rich set value and the lean set value corresponding to the first parameter and the second parameter. According to the map shown in FIG. 4, as the first parameter indicates larger variation in air-fuel ratio between the cylinders, the rich set value and the lean set value used in the target air-fuel ratio switching processing are set to values away from the stoichiometric air-fuel ratio. In addition, according to the map shown in FIG. 4, as the second parameter indicates stronger variation in gas impingement degree of the exhaust gas between the cylinders, the rich set value and the lean set value used in the target air-fuel ratio switching processing are set to values away from the stoichiometric air-fuel ratio. Accordingly, as the variation in air-fuel ratio between the cylinders is larger and the variation in gas impingement degree between the cylinders, with which the exhaust gas exhausted from each of the cylinders impinges on the second air-fuel ratio sensor 34, is larger, the amplitude of the target air-fuel ratio in the target air-fuel ratio switching processing is increased.

As in the embodiment in FIG. 3, in a case where the amplitude setting processing is executed in response to an increase in the variation in air-fuel ratio between the cylinders and the variation in gas impingement degree between the cylinders at time t1, the amplitude of the target air-fuel ratio from the air-fuel ratio center value is increased. Accordingly, a lean degree of the target air-fuel ratio in a period after time t1 is larger than that before the increase in the amplitude. As a result, since the first exhaust gas cleaning catalyst 22 and the second exhaust gas cleaning catalyst 24 can be effectively utilized, an amount of insufficiently cleaned gas, such as NOx flowing out downstream of the second exhaust gas cleaning catalyst 24 in a flow direction can be reduced as compared with the comparative example.

### 3-2. Parameter Calculation Processing

The control of the engine 10 executed by the ECU 30 of the internal combustion engine system 100 includes parameter calculation processing. The parameter calculation processing is executed in a parameter calculation processing unit 318 of the ECU 30. The parameter calculation processing of the present embodiment includes first parameter calculation processing of calculating the first parameter used in the amplitude setting processing based on an operation condition of the engine 10. In addition, the parameter calculation processing of the present embodiment includes second parameter calculation processing of calculating the second parameter used in the amplitude setting processing based on the operation condition of the engine 10.

In the first parameter calculation processing, a fuel flow rate of each of the cylinders and the engine rotation speed NE detected by the rotation speed sensor 36 are used as the operation condition of the engine 10. Further, in the first parameter calculation processing, the engine rotation speed NE and the engine load KL calculated based on the intake air amount Ga detected by the air flow meter 16 are used as the operation condition of the engine 10. As the fuel flow rate, an instruction value of the amount of fuel injected from the injector 8 of each of the cylinders may be used, or the fuel flow rate for each of the cylinders may be detected by a fuel flow meter. The ECU 30 stores a first parameter calculation map in which a relationship between the engine rotation speed NE, the engine load KL, the fuel flow rate of each of the cylinders, and the first parameter is defined, in the ROM. In the first parameter calculation processing, the first parameter corresponding to the detected engine rotation speed NE, engine load KL, and fuel flow rate of each of the cylinders is specified from the first parameter calculation map.

The internal combustion engine system 100 may be configured as an HEV system including a motor generator MG. In this case, the variation in torque for each of the cylinders may be calculated using the motor generator MG, and the first parameter may be calculated by estimating the variation in air-fuel ratio for each of the cylinders from the variation in torque for each of the cylinders.

In the second parameter calculation processing, the engine rotation speed NE detected by the rotation speed sensor 36 and the engine load KL are used as the operation condition of the engine 10. The engine load KL is calculated based on the engine rotation speed NE and the intake air amount Ga detected by the air flow meter 16. The ECU 30 stores a second parameter calculation map in which a relationship between the engine rotation speed NE, the engine load KL, and the second parameter is defined, in the ROM. In the second parameter calculation processing, the second parameter corresponding to the detected engine rotation speed NE and engine load KL is specified from the second parameter calculation map.

In an engine with a turbocharger including a wastegate port and a wastegate valve that opens and closes the wastegate port, a flow speed of gas passing through the wastegate port is faster than a flow speed of gas passing through a turbine. Therefore, in a case where an engine operation condition changes and a ratio of the gas passing through the turbine and the wastegate port changes, a degree to which the gas passing through the wastegate port impinges on the second air-fuel ratio sensor 34 also changes.

The engine 10 may be an engine with a turbocharger including a wastegate port and a wastegate valve. In this case, in the calculation of the second parameter in the second parameter calculation processing, the parameter calculation processing unit 318 may reflect the states of the engine rotation speed NE and the engine load KL in the calculation of the second parameter. In addition, a state of the wastegate valve may be further reflected in the calculation of the second parameter. In this case, the ECU 30 may store the second parameter calculation map in which a relationship between the engine rotation speed NE, the engine load KL, an opening degree of the wastegate valve, and the second parameter is defined, in the ROM.

### 4. Specific Processing Executed in Internal Combustion Engine System according to Embodiments

Next, specific processing of a routine executed by the ECU 30 during the operation of the engine 10 will be described with reference to the flowchart.

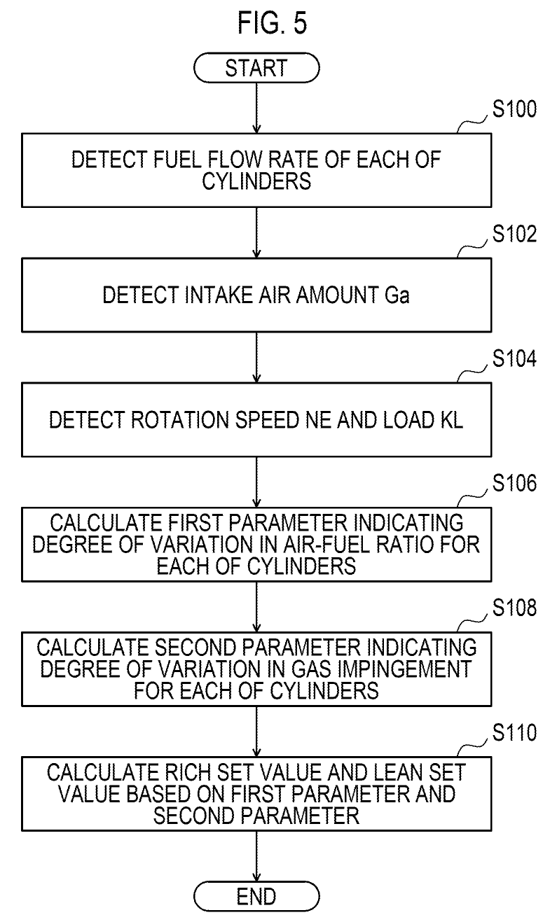

FIG. 5 is a flowchart showing a routine of processing executed in the internal combustion engine system according to the embodiment. The routine shown in FIG. 5 is repeatedly executed in the ECU 30 during the operation of the engine 10.

In step S100 of the routine shown in FIG. 5, a fuel flow rate of each of the cylinders is detected. Here, for example, an instruction value of the amount of fuel injected from the injector 8 of each of the cylinders is detected as the fuel flow rate of each of the cylinders. In a case where the processing of step S100 is completed, the processing proceeds to step S102. In the processing of step S102, the intake air amount Ga is detected by using the air flow meter 16. In a case where the processing of step S102 is completed, the processing proceeds to step S104. In step S104, the engine rotation speed NE is detected by using the rotation speed sensor 36, and the engine load KL is detected from the intake air amount Ga and the engine rotation speed NE. In a case where the processing of step S104 is completed, the processing proceeds to step S106.

In step S106, the first parameter calculation processing is executed in the parameter calculation processing unit 318, and the first parameter indicating the degree of variation in air-fuel ratio for each of the cylinders is calculated. Here, the first parameter corresponding to the fuel flow rate of each of the cylinders detected in step S100 and the engine rotation speed NE and the engine load KL detected in step S104 is calculated from the first parameter calculation map described above. In a case where the processing of step S106 is completed, the processing proceeds to step S108.

In step S108, the second parameter calculation processing is executed in the parameter calculation processing unit 318, and the second parameter indicating the degree of variation in gas impingement strength for each of the cylinders is calculated. Here, the second parameter corresponding to the engine rotation speed NE and the engine load KL detected in step S104 is calculated from the second parameter calculation map described above. In a case where the processing of step S108 is completed, the processing proceeds to step S110.

In step S110, the rich set value and the lean set value for varying the air-fuel ratio in the target air-fuel ratio switching processing are calculated. Here, the rich set value and the lean set value corresponding to the first parameter calculated in step S106 and the second parameter calculated in step S108 are calculated by using the map shown in FIG. 4. In a case where the processing of step S110 is completed, the processing of the present routine is ended.

With the internal combustion engine system 100 according to the embodiment configured as described above, the amplitude of the air-fuel ratio in the target air-fuel ratio switching processing is increased in the following cases. In a case where the variation in air-fuel ratio for each of the cylinders and the strength of the gas impingement for each of the cylinders are large, the air-fuel ratio center value may be learned to a value shifted from the stoichiometric air-fuel ratio in the learning control processing. Accordingly, since the first exhaust gas cleaning catalyst 22 and the second exhaust gas cleaning catalyst 24 can be effectively utilized, the amount of insufficiently cleaned gas, such as NOx flowing out downstream of the second exhaust gas cleaning catalyst 24 in the flow direction can be reduced.

What is claimed is:

1. An internal combustion engine system comprising:
a first exhaust gas cleaning catalyst disposed in an exhaust passage of an internal combustion engine including a plurality of cylinders;
a second exhaust gas cleaning catalyst disposed downstream of the first exhaust gas cleaning catalyst in an exhaust flow direction;
a first air-fuel ratio sensor disposed upstream of the first exhaust gas cleaning catalyst in the exhaust flow direction in the exhaust passage;
a second air-fuel ratio sensor disposed downstream of the first exhaust gas cleaning catalyst in the exhaust flow direction in the exhaust passage and upstream of the second exhaust gas cleaning catalyst in the exhaust flow direction in the exhaust passage; and
a control device configured to control the internal combustion engine, wherein the control device is configured to execute:
feedback processing of performing feedback control of an air-fuel ratio of exhaust gas exhausted from the internal combustion engine such that a first air-fuel ratio detected by the first air-fuel ratio sensor reaches a target air-fuel ratio;
target air-fuel ratio switching processing of alternately varying the target air-fuel ratio between a lean side and a rich side from an air-fuel ratio center value;
learning control processing of setting, based on a second air-fuel ratio detected by the second air-fuel ratio sensor, the air-fuel ratio center value in the target air-fuel ratio switching processing;
first parameter calculation processing of calculating a first parameter indicating a variation in an air-fuel ratio for each of the cylinders of the internal combustion engine;
second parameter calculation processing of calculating, based on an operation condition of the internal combustion engine, a second parameter indicating a variation in a gas impingement degree for each of the cylinders, the gas impingement degree being a degree to which the exhaust gas exhausted from each of the cylinders of the internal combustion engine impinges on the second air-fuel ratio sensor; and
amplitude setting processing of setting, based on the first parameter and the second parameter, an amplitude of the target air-fuel ratio in the target air-fuel ratio switching processing.

2. The internal combustion engine system according to claim 1, wherein in the amplitude setting processing, the control device is configured to set the amplitude to a larger value as the first parameter indicates a larger variation in the air-fuel ratio for each of the cylinders.

3. The internal combustion engine system according to claim 1, wherein in the amplitude setting processing, the control device is configured to set the amplitude to a larger value as the second parameter indicates a larger variation in the gas impingement degree for each of the cylinders.

4. The internal combustion engine system according to claim 1, wherein in the target air-fuel ratio switching processing, the control device is configured to vary the target air-fuel ratio to the lean side when the second air-fuel ratio detected by the second air-fuel ratio sensor is equal to or less than a rich determination value that is richer than the air-fuel ratio center value, and vary the target air-fuel ratio to the rich side when the second air-fuel ratio is equal to or greater than a lean determination value that is leaner than the air-fuel ratio center value.

5. The internal combustion engine system according to claim 1, wherein in the learning control processing, the control device is configured to
calculate an oxygen storage capacity during a period in which the target air-fuel ratio in the target air-fuel ratio switching processing is varied to the lean side and an oxygen consumption amount during a period in which the target air-fuel ratio in the target air-fuel ratio switching processing is varied to the rich side, based on the second air-fuel ratio detected by the second air-fuel ratio sensor, and
set the air-fuel ratio center value such that the oxygen storage capacity and the oxygen consumption amount are equal to each other.
